(19) United States
(12) Patent Application Publication
(10) Pub. No.: US 2004/0249797 A1
(43) Pub. Date: Dec. 9, 2004

(54) Background data storage

(75) Inventors: Richard Jarvinen, Tampere (FI); Matt Millar, London (GB)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/456,953

(22) Filed: Jun. 6, 2003

(51) Int. Cl. G06F 7/00

(52) U.S. Cl. 707/3

(57) ABSTRACT

The invention relates to data processing method in a low memory electronic device. The data is scanned according to various criteria in an active storage file, wherein the data matching to said criteria is transferred from the active storage file into a passive storage file. When data is searched the data in the active storage file is searched at first, and if the wanted data is not found there, the data in the passive storage file is searched next. The invention also relates to a device utilizing said method and to a system as well as to a computer program implementing said method.

### FIELD OF THE INVENTION

The present invention relates to the field of data processing and more in detail to the field of data management in portable terminals.

### BACKGROUND OF THE INVENTION

Due to the increasing wants of the users and due to the possibilities provided by the developing communication technology, increasingly more data should be processed in portable low memory electronic devices comprising networking capabilities. Imaging applications, with still images, videos, as well as the gaming and service applications with network browsing require a great portion of a memory, wherein lesser memory is required by basic applications. Similarly, it is foreseen that also the basic applications such as calendar, contact book, note book and other used mainly as a data storage for personal data, will require ever more memory due to multimedia content.

When talking about low memory electronic devices, they are understood as handheld organizers such as personal digital assistants (PDA), cellular phones, communicators or other portable terminals with some communication capabilities build in the device or with an interface to a communication network. Communication is to be understood here as a method for transferring data, e.g. voice, text, image and video, through a data or telecommunication network to or from said terminal. The network can for example be a wireless network with a short (e.g. WLAN, Bluetooth, Infrared, HiperLan2) or a long range (e.g. GSM, GPRS, WCDMA, UMTS) radio frequency.

As said, the amount of data is increasing in the low memory terminals, wherein a need for a storage is increasing as well. One example of storable data is an electronic contact book with contact records. A contact record stored into memory of the electronic device can be a phone book entry or it can be in the form of a vCard, which is used typically in Personal Data Interchange (PDI) through a network or wirelessly between terminals. The vCard comprises uniquely named values, which are placed into vCard data stream. The basic form of the vCard is the following:

BEGIN:VCARD

PropertyName [‘;’ PropertyParameters]‘:’ PropertyValue

END:VCARD

There can be various property fields in the data stream depending on the records. Typically fields consist textual and numerical personal/business records such as a name, a telephone number, an email address, etc. Along with this basic information other types of information is also included, which affects the consumption of the memory. This other information can be graphics and multimedia with photographs, video and audio clips etc.

It is known, that graphics and multimedia information requires a far greater amount of memory than basic information, wherein the low memory devices are forced to expand the storage space into external media such as e.g. memory cards. This forwards into problem where the data stored in the memory card is not available when the external media is not present. In such a case, when a person contacts the user, e.g. by phone, the calling line identity feature commonly used in portable phones will not return the calling person's name.

Typically, and especially in contact application or phonebook application, the amount of the data is increasing due to the usage. New contacts and entries are added, when new people are met. Especially the users of intelligent communications tools, such as Nokia 9000 series Communicators, ordinarily exchange Business Cards electronically, by sending the contact card to each other via SMS (short message service), as disclosed in applicants former application U.S. Pat. No. 6,049,796, filed on 11^{th} Apr., 2000. The users of basic communication tools, such as cellular phones, ordinarily exchange Phone Book entries electronically, by SMS or Infrared. Correspondingly old contacts need cleaning for the sake of the usability. Cleaning means removing the old data records, wherein more memory is freed for the newer ones. For every data record, the choice of which information is more important than the other and which can be removed, is to be made during the cleaning process. This takes time and requires too much effort from the user.

### SUMMARY OF THE INVENTION

The object of this invention is to provide an improved method for managing data in portable terminals, where the data management has an improved usability than the methods in prior art. This is done by storing all the data in the reach of the terminal but keeping rarely-used data away from often-used data.

This object is achieved in a method for processing data records in a portable terminal having a main memory, an auxiliary memory and a search engine. The data records in the main memory are scanned according to a various criteria, wherein the data record that meets said criteria is transferred to the auxiliary memory. Due to this the data records can be divided for passive (rarely-used) and active (often-used) data. When an end-user is looking for a data, the active data records in the main memory are searched first. If the wanted data is not found there, the searching is done for the passive data in the auxiliary memory. If the wanted data is found there, the data is returned to the active data and to the main memory

A data record can obviously be any data record that are utilized during a usage of a terminal. Data record is preferably a contact record, a calendar record, a note, a piece of a game, etc. The main thing is that the data record is somehow used in the communication as in e.g. multi-user games or in other exchange of information. The ideal situation for the use of the invention is when the terminal stores a large amount of data (many contact records, many days in the calendar, many game characters, etc.), but it is obvious the amount is not the determining factor. Said often-used data in the calendar can be dates of a month following the current day, wherein the rarely-used data can be past dates and dates after the following month. Often-used data can vary depending on the seasons, e.g. a school semester or a fishing /hunting season. When that season has gone by, the information of that season changes to the rarely-used data. The often- and rarely-used data in the note-book can be classified similarly. The contact book with contact records and phone book entries is used as an preferred example so it is further described in beyond.

A terminal, for which the invention is invented, is an electronic device utilizing the above-mentioned method and comprising a main memory, an auxiliary memory and a search engine. Additionally it comprises a scanning means for scanning the data records according to a various criteria and means for transferring, and optionally means for compressing and uncompressing data. The scanning means is adapted to scan the active data records entirely, wherein it checks if a determined criteria is met by some record. In that case the data record is transferred, and if desired in compressed form, to the auxiliary memory. The search engine is adapted to search the often-used, active data at first, wherein if the searched data is not found, the searching is done for the rarely-used, passive data. The terminal is preferably a portable, nowadays a low memory device, comprising also means for communication and/or data transfer. Example of such a terminal is a personal digital assistant, a cellular phone, a communicator and a smart phone etc. It is obvious that the invention can be utilized with other terminals as well. The terminal according to the invention can be used along with an auxiliary memory means, which stores the data records. The auxiliary file storage means can be a Subscriber Identity Module (SIM) or other memory cards such as Compact Flash® -card, MultiMediaCard® (MMC) and Secure Digital® card (SD) which are removable from the terminal. The invention could be applied also to hard disks, floppy disks or remote memory means over a network. The auxiliary memory means is, according to one embodiment of the invention, used for storing the content of the data record, wherein the main memory means within the terminal is used for storing entries of the content. In this situation it is also possible to use the remote server or other non-local storage space, which is reached through a network.

The invention also relates to a system and a computer program product for implementing the method according to the invention.

One advantage of the invention is that the usage of the memory is saved due to the compression of the passive data, which usually is a bigger part of a memory. And by courtesy of that, a user can save and carry a larger amount of active data with the terminal.

Another advantage of the invention is that the usability of the data improves. By identifying and moving the old and rarely-used data to another memory means, the often-used data will become more comfortable and quicker to handle. Also the available main memory comprises only a fresh information without being mixed with the old information. The need of “cleaning” is reduced for not keeping all of the data in the view. This means that necessary and unnecessary (or accidental) deletions of data records will be reduced by superseding the rarely-used data to the auxiliary memory.

When using the several memory means for storing the data the prior art methods require the user to choose whether to use the main memory or the other. The method of the invention provides more flexible way to store the data. When the main memory stores the entry of the content (e.g. a name) and the auxiliary memory stores the rest (the content) of the data (e.g. contact information, image), the scanning of the information is possible even without the connection with the auxiliary memory. By using the non-local storage space for the auxiliary memory, it is possible to store even larger files, because the amount of the main memory is not limited by a size of the memory or a power consumption.

### BRIEF DESCRIPTION OF THE DRAWINGS

The preferred embodiment of the invention is set forth in the drawings, in the detailed description which follows, and in the claims annexed to. Further objects and advantages of the invention are also considered in the description. The invention itself is defined with particularity in the claims.

FIG. 1 is a principled illustration of an electronic device according to a invention,

FIG. 2a is a frontal view of a telephone unit utilized with an electronic device,

FIG. 2b is a frontal view of a PDA unit utilized with an electronic device,

FIG. 3 illustrates a view of the contact card,

FIG. 4 illustrate various views of the contact directory, when an image is added,

FIG. 5a-d illustrate various views of the contact directory, when a contact is searched

FIG. 6 is a flowchart detailing the data scanning according to the invention,

FIG. 7 is a flowchart detailing the data searching according to the invention, and

FIG. 8 is an example of a storage structure according to the invention.

### DESCRIPTION OF THE PREFERRED EMBODIMENT

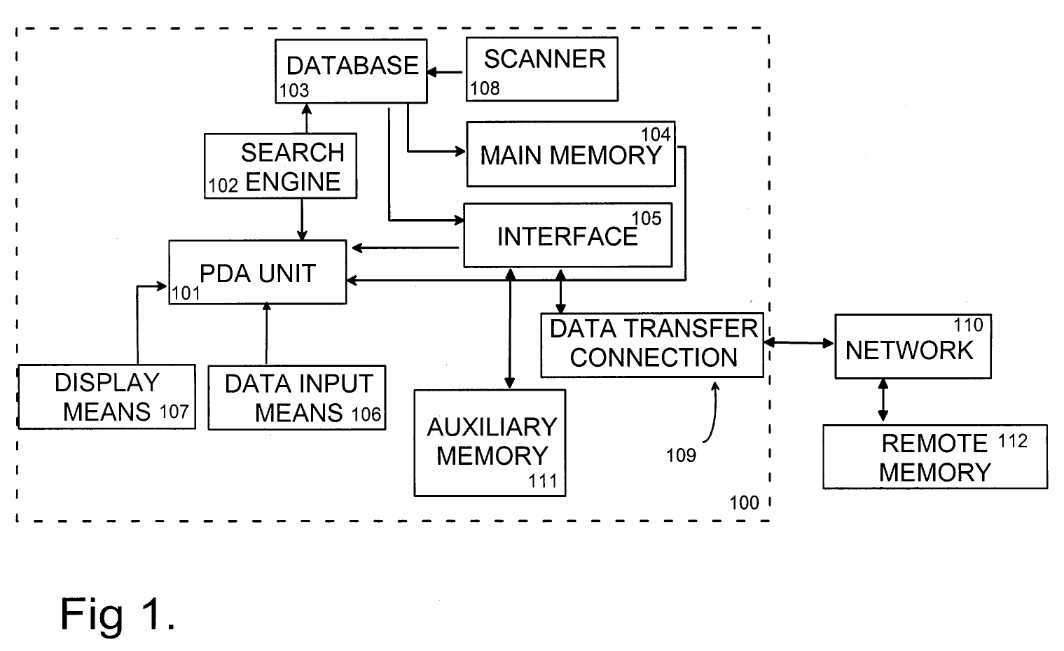

FIG. 1 is a high-level illustration of a terminal 100 that comprises of a PDA unit 101, a search engine 102, a main memory mean 104, an interface 105 to the auxiliary memory means 111, 112 and an data transfer connection 107, said data being text, voice, image, video or similar in binary format. The data transfer connection is preferably a telephone packet data or circuit switched data connection, but it can be also another network connection, such as a WLAN-card, a Bluetooth module, an Infrared-connection or an optical fiber cable, in addition or without the telephone connection. The terminal 100 according to the invention comprises also a database 103 and a scanning means 108 for monitoring data. The terminal 100 comprises also a display means 107 and data input means 106.

The terminal 100 according to the invention has also means for storing data in an auxiliary memory as illustrated in FIG. 1 by reference numbers 111, 112. This kind of an external medium can be, for example, a SIM-card, a MMC-card or a comparable displaceable medium 111. Correspondingly the data can be stored in a remote memory means 112 , e.g. a server, being reachable through network 110, said network 110 being a wireless short or long radio frequency network, e.g. WLAN, Bluetooth, Infrared, GSM, GPRS, UMTS, WDCMA or a wired network with USB or serial cables.

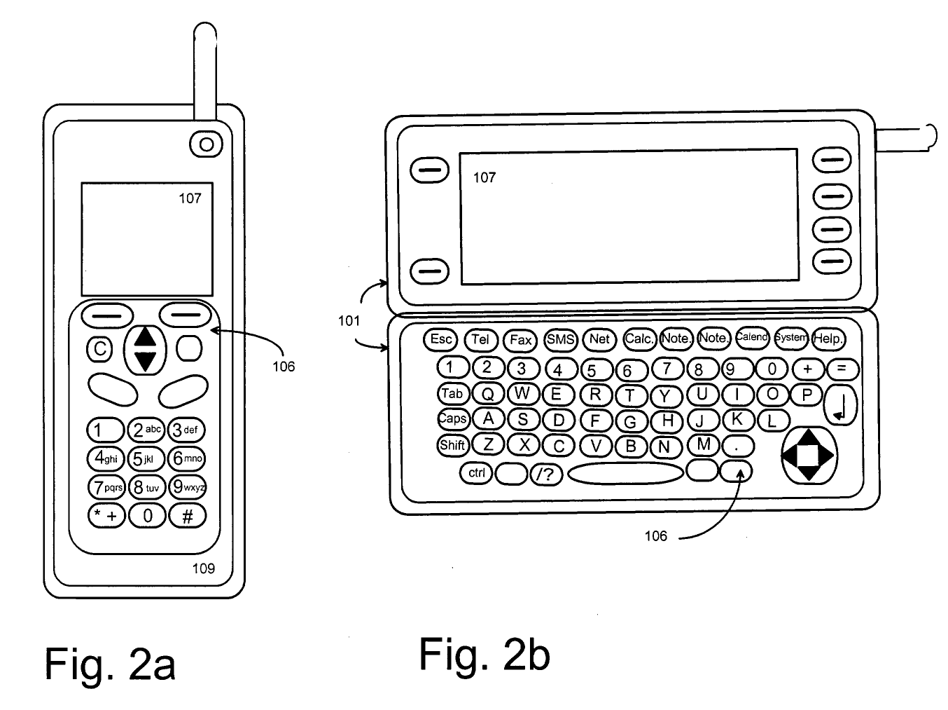

One preferred embodiment of the terminal 100 utilizing the invention is illustrated more in detail in FIGS. 2a and 2b. This embodiment comprises a data transfer connection as a telephone unit 109 (FIG. 2a) and a PDA unit 101 (FIG. 2b) which are interfaced together electronically and mechanically. In this example the PDA unit 101 is covered by a hinged telephone unit 109. The terminal 100, according to the invention, comprises also at least one display 107 for showing data for the user. Additionally the terminal 100 comprises also some kind of input means 106, for example a keyboard or a stylus.

The contact database 103 contains contact information in a form of a contact card, e.g. a vCard or a phone book entry. The database is divided into active and passive data records. There can be several active data files for storing the records, wherein these files can be created by the user. The data files can both be used by different applications, e.g. email application etc., but the management—creating, deleting and editing of data records—is handled by a specific application as, in this embodiment, the contact application or the phone application.

Contact Card Creation

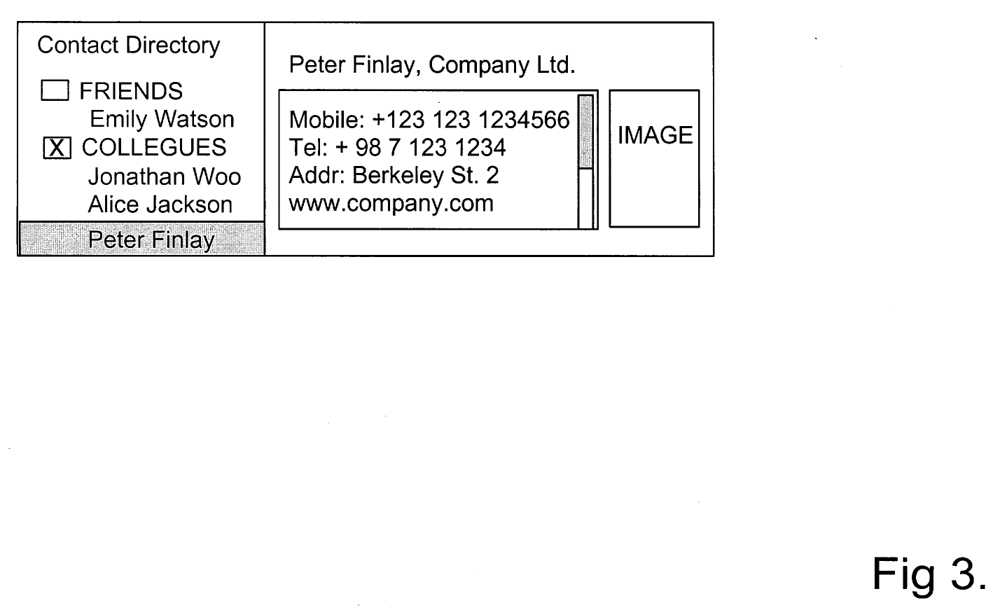

Example of the one embodiment of the data record is shown in FIG. 3. This embodiment shows data record by a contact card. The card contains contact information, such as name, telephone number, e-mail address, telefax etc. In addition there can be also a picture of a person, a ringing tone for the person, video or audio clip of the person and other featuring elements.

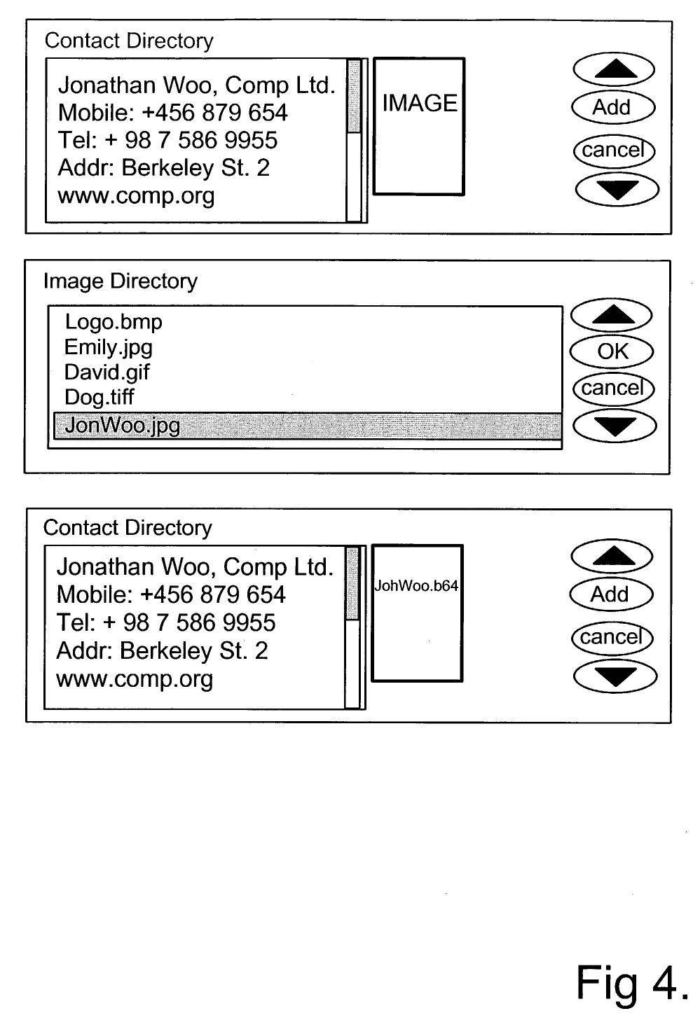

The creation of a contact card follows the way presented in applicants application U.S. Pat. No. 6,049,796. The contact card comprises fields for different information. The fields can be added and removed depending on the situation and on the data, which is to be placed in the cards. When an image is included, it is embedded into the contact card, according to the invention, by the following way. The example is shown in FIG. 4. The field for the image is activated and the function “Add” is chosen. The browser moves to the directory comprising images in gif-, tiff-, .jpg- or any other image format known as such. The wanted image (JohnWoo.jpg) is found by using e.g. arrow buttons and selected. The chosen image is converted automatically by the contact application to the base64 format (JohnWoo.b64). The base64 encodes the data by representing the 24-bit groups of input bit as output strings of four encoded characters. The 24-bit group is formed by concatenating three 8-bit input group and these twenty-four bits are handled as four concatenated 6-bit groups, out of which each is translated into a single digit in the base64 alphabet. Each 6-bit group is used as an index into an array of sixty-four printable characters. The character referenced by the index is placed in the output string. An example of an image data (comprising also an image field code of the vCard) is represented below: PHOTO; ENCODING=BASE64:/9j/4AAQSkZJRgABAQMUABgAAD/2wBDBA LDA4MChAODQ4SERATGCgaGBYWGDEjJR0oOjM9PDkzODdASFxQERX RTc4UG1RV19iZ2hnPk1xeXBkeFxlZ2P/2wBDARESEhgVGC8aGi9jQjhCY2N jY2NjY2NjY2NjY2NjY2NjY2NjY2NjY2NjY2NjY2NjY2NjY2NjY2NjY2NjY2NjY2P/wMRCABgAFADAS IMhEBAxEB/8QAHwAAAQUBAQBAQAAAAAAAAA ACAwQFBclQoL/8QAtRAAAgEDAwlEAwUBAQAAAF9AQIDMQRBRIhMUE GE 1FhByJxFDKBkaEII0KxwRVS0fAkM2JyggkKFhcYGRoIJcoKSo0NTY3OD k6QORFRkdISUpTVFVWV1hZWmNkZWZnaGIqc3R1dnd4eXqDhIWGh4iJipK TIJWWI5iZmqKjpKWmp6ipqrKztLW2t7i5usLDxMXGx8jJytLT1NXW19jZ2uHi4+TI5ufo6erx8vP09fb3+Pn6/8QAHwEAwEBAQEBAQEBAQAMMAAMECA wQFBgcIQoL/8QAtREMgECBAQDBAcFBAQMQJ3AAECAxEEBSExBhJB UQdhcRMiMoEIFERobHBCSMzvAVChYkNOEI8RcYGRomJygpKjU2Nzg5Ok NERUZHSEIKU1RVVIdYWVpjZGVmZ2hpanN0dXZ3eHI6goOEhYaHiImKkpO UIZaXmJmaoqOkpaanqKmqsrO0tba3uLm6wsPExcbHyMnK0tPU 1dbX2Nna4uPk5ebn6Onq8vP09fb3+Pn6/9oADAMBMIRAxEAPwDnI0+fkB FyBnBb/wCv U0WmXUhIEYOAD+H51orKC5bMOQDgYPP6VM+2O+MQ2ghVHBxxtB9Kp0 1f/h/8jNVJJaGUdHuhKFMIwfQA1Kmg3LYxF1/2RVsvvuCFjbjPPmfrV0IxX5Mg HGcnNROMYK7f4f8ABNlOc3ZfmZx0R4seY6qSO6gUq6UGIAnTJ9hWgISx+c 9PU5qK4TGxIwc5yfbANYqor7Gzpu25Yj8ObY8yXADHsMcU6PRE8za1xgAcn NW7HU3kjZJmbzQeG4wwqR5iJMrI54yTxg/rXTFRkrp/kcsnKLaf6kd pEMrvmc 4B4we1WJfDyMR3DA/U1Jo8zGYrvY55wcY4/GtdwSw5pOCT0YKpK3/APO A5KIhM3Hfyx/jTr6UC+IIkbIbA+Qdhj19qqvcLDgSSzLnnBbGf1ptxqVs80jC4nw zEjFW4rr+gJvp+pZgYeaCvJ91x/WtIXCRKPMcD61gNrUKJhRIXxjd nPf0oh1ey U5kt2cnqWOa5pxcv6R0Qkkt/zN37dBn7+R9KT7TDuBWQZrOXXLDH+owPQ LQ+saY3WI/gtT7N9vxRp7Rd/wNqJo5fIG3c3AIPU077aDg7EA2jlyeP1rmzqen o4eFpoyD25FPfKLeSRmDzANzj0reknFtf5HPWaIZ/5nYaVMm9Gwg65Iz/jW8ZEyB6815/Y+17SEqGMxx37Vv2mqRT3SSJNu RhkZccZHpmtnG+v6o572/wC GZ51fbxdOHOVBO3njHaqpl9f0rp5LaG9eOOWVypYAYiAIz7g1kXGkSqw8jM oOe2CP1rCT1u/6+9L8joinsk/u/wCH/MpRWs00yxqp3N0z/OuksfCizxAvcqCey DOKW50fdpEFzbIII2KNnqQBu5+oPFY0SyooAkdT7E1g5XW9jqhT5d1e6On/A OEJiIGLts+6/wD16hm8FMozHcKx9CKraLdambtYIJd4IJKycgAdye1F/reqrcSx CVY/LJBBMPP1NTZ9JGj01cfwRn6poU9jGXbDKOcr0FY2CK1bvUb+4QpNO XUjBBA5qjNC0UvIkZIAOBz1FaxvbV3Oaqk3orEa5ziuh8NsypMXB2gjHGR3z1 IqhY6a8o3sQgzjJ4P4Cugg2QRLGkcYX2z19etb0073toc87WtfX1CLeZ0y7kAg 4eX/AOvUJ RSfmSA+5mJP86uxBBICGg79IyT0+gphD9QrD/rn ER/MitW33a+c kZpJ9L/JP8miS0u1EC22FBSQIcHIAIGR19Sa0WsbG5j/AHIuhJ7jg/pWdbRu/w BokaSTy4IL4PcgDjGT6itWIZX5CRnn8+o/PNedWtzafnf9Eeth3LIs+m3T9WMs 7WzspGChYs8Zbv8AjVRtOsd RuZpMk4IG9Twfb0NXZQzArJGrrjjnGaZHvRC AiRqB2P8A9as01Y6LN6mRqGI2dvGRDEXIIyM kk/IVO03t0IBZG34BDZUHPfk /hVu4kafU0ii2sWJyXGQB64+gzTry2mtpQrxIdvQrGMNkdBz/AJ4rroOKsm9X3uefirt6LRdrDFZf+e7D6zAf1pQ754mU/wDbf/7KIAUgHa4HYhRj/wBCp6pz8skg P+8v/wAXXR7qfT72jjadtb/cn+RajDs38bDB/h Udvoalt7Eykl0IQA95Ov5AVzcut SSA+WgQgnkkkkenJIrtNOkiIjt3hO6J14P8v8+tY1JOEfd0/D8nb8C6cVJ3ev3P 80mZ9zbNao8almVi6N6kMMgn6bcfhVq4ikiKzxDKjI1Hceop+qcXUIzgNIPbOC R/6D+tWbUhiMTdQOPcVxtNpM7Yzs2iuIxbSICJV6dzisfU75WYQWxDM3Bx0 FatzpdpIzGWDDeo4zVSHToYZC0Ue0dAetNcu7Nveez0MzQIJkvJpXUyTMzK q55ABBJ/EV1A8u4Vy/Q8Z6Yx3BrCZ4Iv38h8tGoLITwDngZ9etbd mS9sQAOp xRNXs+pz3SbRi3Vo1o2AF8o427ixlGOn3h6GogEYDIH41IT/7NXTS26zRIHJH HUHBz7Vy6X8a3DW8hxIrFTI2wSCR1z7V10KrkrNu69H+ZyVaai7pK3zX5HJu ccg4JFdP4U1ZbZktLIsITICegJ7H61y55VasRnBzVzipKzFFtO6PTLq1E8Qzy6nerepxxWddBysZUkYbBwcHcYPsf5VLoupGeGO3uHBn8sSKw/jUjr9Qcg+4qe 5iU3Kkjj7wHvyD/P9a5EmnZnQ2nqjmLN9S064aFpBKnBRnUZIPv61mXOu39yNjTbF77Biuu1ixS60yYFRvVCynHQgZH54xXG6TZG8vlQgIF+ZvoD0/Ot4pN Xa2Ic5bJnQW2n/ZUVDgsRyRyc8ZNd NBb+VAFI5xnioLa1UyoTzsOT7/5JqLXt Zi0u3K5zcMDtUc49zWEk5uyKi0ldkOua0mnReWmGuGHyj09zXBTOzszkkkn Jz6mrI7I9xb2107bmYvG5PUsCW/kwH4Vnu2VNdNKmoJ9zKcm35AD/2Q==

The double “=” characters at the end of the encoded stream stand for the final unit. The length of the stream depends on the size of the image.

When the image is acquired and converted, it will be fixedly part of the contact card. In other words, the image in the contact card is not a link into the image directory and not utilized straight from there, but is a part of the contact card, wherein the image can be removed from the directory without harming the contact card. Because the base64- encoded image is smaller than known image format it thus saves memory and thus allows easier embedding. It is also possible to use a base64-directory with only base64-images, wherein the directory can also be utilized straight by linking the image field into it.

The contact card can also comprise other personal information which consumes a lot of memory. For example there can be a curriculum vitae comprising the basic information as well an image of a person and even a video or an audio clip of a person. Choices of the usage are unlimited, but the size of a contact card is increasing in relation to the number of the fields.

Contact Card Management

The management of contact cards is described by a following example. The user has in his terminal several (e.g. 500) contact cards. The scanning means 108 monitors the data continuously, or periodically, and checks whether the active data record meets predefined conditions. The scanning means 108 is adapted to monitor the data, for example, from the log file of the electronic device 100. It is also possible to adapt the scanning means 108 to make a mark into some other log file every time a data record is somehow used e.g. accessed, called to, called from, communicated to, communicated from, modified, checked, viewed, searched for. One of the predefined criteria can be the data usage, wherein the scanning means 108 checks when was the last time the contact card 301 was picked for the above-mentioned reasons. The criterion can also be some other feature of the data, for example the size of the data or a frequency of the usage. Preferably the criteria to be met is a function of several criterions. When the scanning means 108 detects the data according to said criteria, the data is transferred into auxiliary memory 111, 112. Before transmission the data is preferably compressed for reducing the memory it requires. By this, contact cards are divided in often-used and rarely-used data, wherein the daily used data can be sought easier.

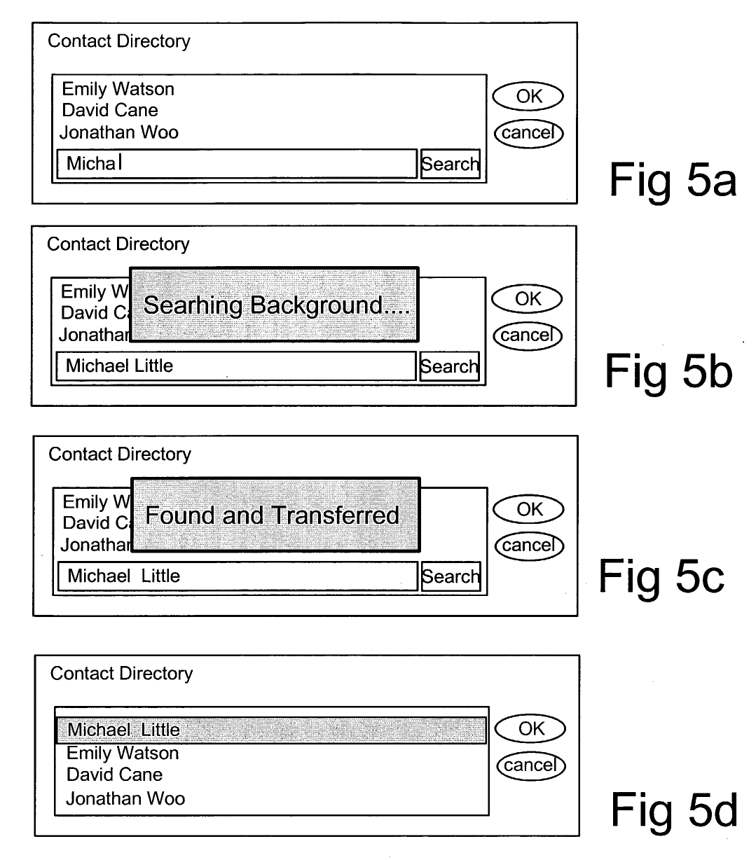

When the user needs a contact information, the search engine 102 is adapted to perform the search on the basis of a search key. The search key is preferably a name of the contact, but naturally it can be some other definition of the contact. In the contact application the search key is defined (FIG. 5a), wherein the search engine 102 starts the search. The main memory 104 with active records is searched at first. If the required data record is not found from there, the search is addressed to the auxiliary memory means 111, 112 (FIG. 5b). The selection of whether to target the search into the passive data records is made automatically or it can be asked from the user. When the wanted data record is found, it is retrieved for the use. The contact is, if compressed, uncompressed and transferred into main memory 104 (FIG. 5c). It is also possible to use the contact only for that time, wherein it is only viewed on the display 107 and brought back to the passive records. When the contact is transferred to the main memory 104 (FIG. 5d) the next active data record is transferred to the auxiliary memory. This way the amount of active records is kept limited in a given size. If there are no data records exactly meeting the passivation criteria, the item nearest to that criteria is passivated.

On the other hand, if the amount of the active records is not limited, the passivation is not done until the next data record meets the criteria. Search from the auxiliary memory 111, 112 can be slower than a search in the main memory 104, due to compressing algorithms and a compression rate.

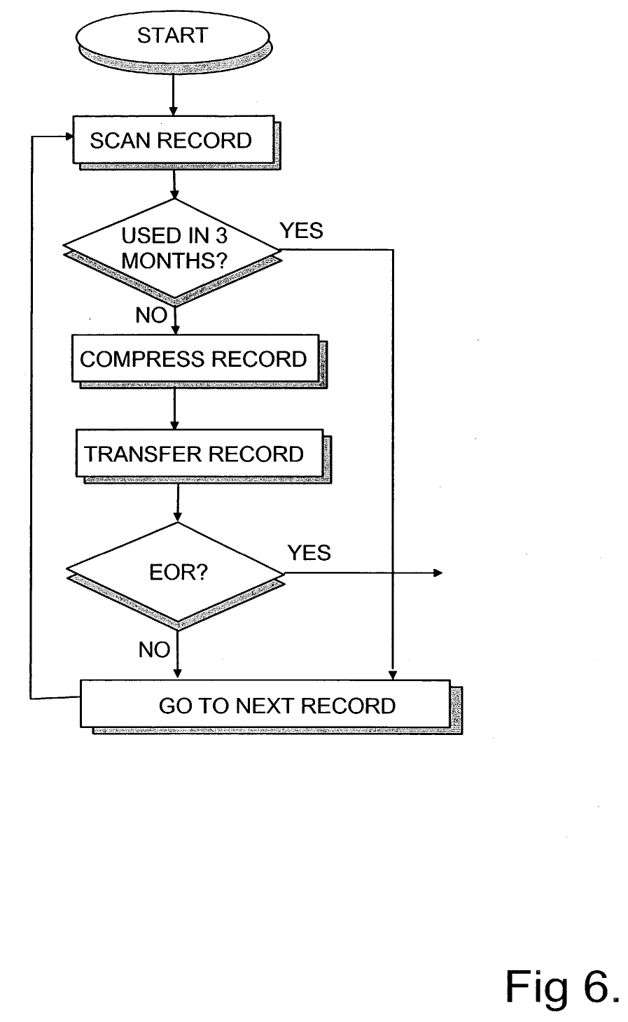

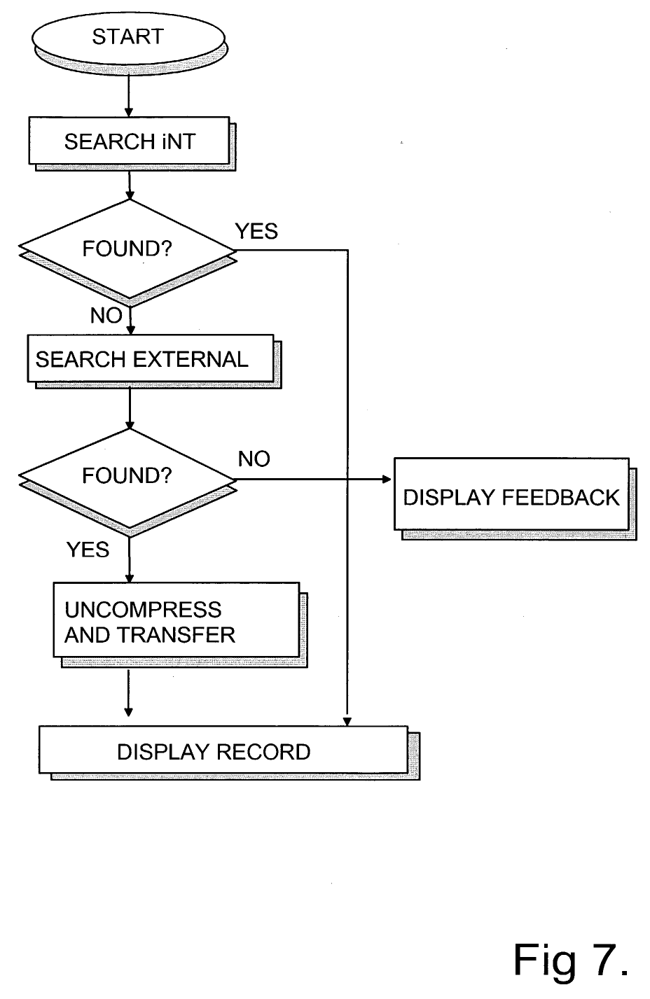

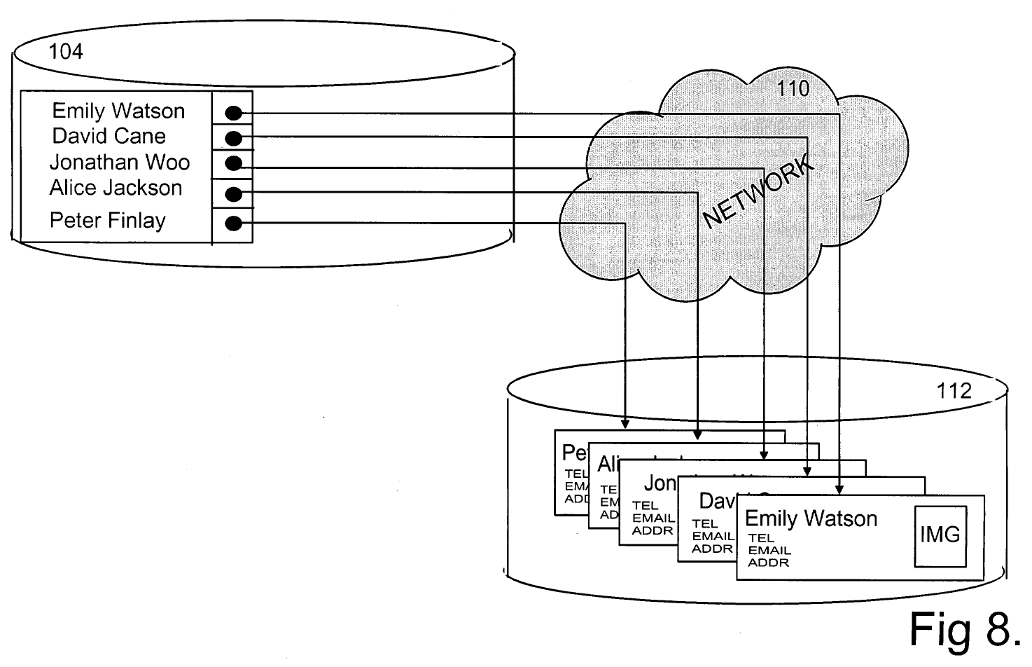

It is obvious that a feedback from the user interface is to be informative and texts used in said figures does not inevitably correspond to the actual situation. In addition, the exterior features of the user interface can vary in a normal situation. The invention is not therefore restricted by the figures. The flowchart illustrating one embodiment of the monitoring is shown in FIG. 6 and the flowchart illustrating one embodiment of the search is shown in FIG. 7.

Contact Card Storage

As described earlier, the contact cards can be stored in different files for an easier management of the data. The files usually comprise categorized information of for example friends, colleagues and relatives. Obviously there can be more files and more categories, or groups, than described here. Some of these files locate in the internal drive of the terminal, but increasingly the databases locate in a removable SIM- or MMC-card 111, which expands the storage space for the terminal 100. In some cases the files can locate in the remote server 112, which is reached through a network 110. In every case the problem in the prior art is the same; when the file is not activated or when the memory card 111 is not present or when the network 110 is currently down, the contact card can not be viewed. This means that whenever some known person contacts the user, only a phone number or an IP-address of the person is shown. In other words, the person is not identified if the file storing information about him is not currently active. One example of the situation in the prior art is to follow. As shown in FIG. 3, the files “Colleagues” is activated (ticked). This means, according to the prior art, that the contact application can utilize the contacts in that file. If a colleague “Alice Jackson” called to the user, the name of hers, “Alice Jackson” is displayed. On the other hand, if a friend named “Emily Watson” called to the user, the phone number of hers is displayed, because the contact information of hers is stored into inactivated file.

For preventing this, the method according to the one embodiment of the invention stores a certain portion of each contact in the internal drive in the main memory 104 and the rest of the contact, e.g. data content, in the auxiliary memory device 111, 112 (e.g. card). The portion of data being kept in the internal drive depends on the size of it. When the contact information is created or imported to the device 100, it is scanned through for identifying the large objects, for example objects in the data stream that are greater than a given size, e.g. 1 kB. These large objects are detached from the main data and stored into auxiliary memory 111, 112. Data that is left to the internal drive comprises at least some identification of the rest of the data, for example a name of the contact, and also a pointer to the location of the rest of the data.

When the user needs a contact, the information in the main memory 104 is viewed first and after choosing one, the data from the auxiliary memory can be presented corresponding the chosen one. If the auxiliary memory was not in the reach, the entries can anyway be scanned. This means that coming phone calls, SMS, MMS or other contacts are matched to names in the users contact list, wherein some information of the caller is substantially always shown to the user.

As mentioned, the storage is not restricted to the local auxiliary memory, but can be implemented also on a remote memory means 112 and used through a network 110 as illustrated in FIG. 7. This allows large files, such as multimedia with audio, video etc. or complicated text files such as templates for invoices or agreements etc. to be held out of the portable terminal 100. Every time such a data is needed, it is acquired from this remote server 112. This is also highly preferable with e.g. company contacts. For example, an exchange number of a company is stored in the internal drive of the terminal 100, and a caller from an extension number having the identifiable prefix number of a company contacts the user, the caller can be identified by using the company contact list in the remote server 112. Due to this not all the contact information of the company employees need to be stored in the internal drive.

In one embodiment of the invention the auxiliary memory is part of the main memory. In that case the main memory comprises uncompressed files for active data records and compressed files for passive records. It is obvious that the utilization of said records follows the method described earlier.

Exchange of Contact Cards

Contact cards can be exchanged between users by using some known data transfer method. In close contacts preferably Bluetooth or Infrared is used. Otherwise contact cards can be transferred by using SMS or MMS messages or by email. It is also possible to transmit the contact card automatically along a phone call.

When exporting or importing the contact cards from the database 103, it is possible to transfer several cards at once contrary to the prior art, where only one card could be transferred. Contact cards are selected from the contact list and added sequentially to the list to be sent. The values in the contact card are transported preferable by using Comma Separated Value (CSV), but other methods, e.g. Tab Delimited Files (TDF), can be used as well. CSV-format includes the values in the fields of a contact card in a row separated by commas. If there are more cards to be transferred there will be that many rows in the CSV-file.

The management system according to the invention can be implemented for an application that is running in the background, scanning the files sequentially. The application is adapted to handle any data and it is capable to share information with other applications as well. The data records are viewed by their functions. If an email-application utilizes the contact database, the email-addresses are shown. Similarly if the function is a phone call, the phone numbers are shown.

Said management application is preferably implemented on the user interface software layer, but it also can be implemented on the operating system level. Also the management system can be a feature of some specific application e.g. contact application, which is used by for example telephone, email, fax applications. In some situation the management system can be implemented in a chip also.

The portable device using said management system is preferably a PDA-device with communication capabilities. An example of such a device is a communicator, which comprises a PDA-unit and telephone unit. The device can also be a handheld organizer which comprises a data transfer connection (e.g. WLAN-card, Bluetooth module, Infrared etc.) or the device can be a cellular phone. Obviously the communicator and the cellular phone comprises also other data transfer connections, like the handheld organizer.

It is obvious that the embodiments described above can also be combined and adapted in various ways. Hence they should not be interpreted as limitations of the invention but they can vary in the scope of the inventive features presented in the following claims.

1. A method for processing data with a portable electronic device comprising a search engine, a main memory means for storing data records and an interface for an auxiliary memory means, said method comprising steps of
defining data records to be stored in the auxiliary memory means as passive, whereupon data records in the main memory means are defined as active,
scanning the active data records in order to identify records fulfilling certain criteria,
transferring the data record matching said criteria into the auxiliary memory means, said transferring indicating the change of a status of a data record from active to passive, wherein, in response to a request for accessing a data record, the requested data record is searched from the auxiliary memory means unless the requested data record is found from the main memory means.

2. The method of claim 1, wherein, if the requested data record is found from the auxiliary memory means, the data record is retrieved to the main memory means.

3. The method of claim 1, wherein the data record matching said criteria is stored in said auxiliary memory means in compressed format.

4. The method of claim 1, wherein a content of the passive data record is stored in the auxiliary memory means and an entry of said content is stored in the main memory means, wherein also a pointer to a corresponding data content in the auxiliary memory means is stored in the main memory means.

5. The method of claim 1, wherein the data record corresponds to a contact card.

6. The method of claim 1, wherein the criteria is one of the following criteria; a usage of the data record, a size of the data record or usage frequency of the data record; or a function derived thereof.

7. The method of claim 1, wherein the interface is for a memory card.

8. The method of claim 1, wherein the interface is for a remote memory means.

9. An electronic device for processing data comprising a search engine, a main memory means for storing data records and an interface for an auxiliary memory means, said main memory means comprising active data records, said auxiliary memory means comprising passive data records, said electronic device comprising also
a scanning means for scanning the active data records in order to identify records fulfilling certain criteria,
means for transferring a data record between said main memory means and auxiliary memory means, wherein the data record matching said criteria is transferred to the auxiliary memory means, wherein in response to a request for accessing a data record, said auxiliary memory means is searched from unless the requested data record is found from the main memory means.

10. The device of claim 9, wherein the means for transferring the data record is adapted to retrieve the data record to the main memory means, if the requested data record is found from the auxiliary memory means.

11. The device of claim 9 further comprising a compressor for compressing the data records to be stored in the auxiliary memory means.

12. The device of claim 9, wherein the auxiliary memory means comprises a data content of the passive data record.

13. The device of claim 12, wherein the main memory means comprises an entry and a pointer to the corresponding data content in the auxiliary memory means.

14. The device of claim 9 comprising also means for telecommunications.

15. The device of claim 9, wherein the data record comprises a contact information.

16. The device of claim 9 comprising also at least one of the following means; means for measuring the usage of the data record, means for measuring the usage frequency of the data record or means for determining the size of the data record.

17. A system for processing data records, comprising a search engine, a main memory means for storing data records and an interface for an auxiliary memory means, said main memory means comprising active data records, said auxiliary memory means comprising passive data records, said electronic device comprising also
a scanning means for scanning the active data records in order to identify records fulfilling certain criteria,
means for transferring a data record between said main memory means and auxiliary memory means, wherein the data record matching said criteria is transferred to the auxiliary memory means, wherein in response to a request for accessing a data record, said auxiliary memory means is searched from unless the requested data record is found from the main memory means.

18. The system of claim 17, wherein the means for transferring the data record is adapted to retrieve the data record to the main memory means, if the requested data record is found from the auxiliary memory means.

19. The system of claim 17 further comprising a compressor for the data records to be stored in the auxiliary memory means.

20. The system of claim 17, wherein the auxiliary memory means comprises a data content of the passive data record.

21. The system of claim 20, wherein the main memory means comprises an entry and a pointer to the corresponding data content in the auxiliary memory means.

22. The system of claim 17 comprising also at least one of the following means; means for measuring the usage of the data record, means for measuring the usage frequency of the data record or means for determining the size of the data record.

23. A computer program product for processing data records, comprising computer readable instructions for searching data from memory, computer readable instructions for storing data records in a main memory means and transferring data records to an auxiliary memory means, said main memory means comprising active data records, said auxiliary memory means comprising passive data records, said computer program comprising also computer readable instructions for
scanning the active data records in order to identify records fulfilling certain criteria,
transferring a data record between said main memory means and said auxiliary memory means, wherein a data record matching said criteria is transferred to auxiliary memory means,
searching the requested data record from said auxiliary memory means unless the requested data record is found from the main memory means.
